(19) United States
(12) Patent Application Publication
(10) Pub. No.: US 2011/0220158 A1
(43) Pub. Date: Sep. 15, 2011

(54) FRUIT AND VEGETABLE CLEANING DEVICE

(76) Inventor: CHING-TSE HO, Taipei City (TW)

(21) Appl. No.: 12/721,533

(22) Filed: Mar. 10, 2010

(51) Int. Cl. B08B 3/00

(52) U.S. Cl. 134/198

(57) ABSTRACT

A fruit and vegetable cleaning device includes a base, a pump, and a pressure vessel. The pump is mounted on the base and includes a water feeding pipe connecting a water inlet port and the pressure vessel. The pressure vessel includes a water discharge port and an electromagnetic valve. The electromagnetic valve includes air inlet and discharge pipes. The pump supplies water to the pressure vessel to allow air to mix with the water inside the pressure vessel, making the water full of tiny air bubbles. As such, residual pesticides remaining on fruits and vegetables may attach to the tiny air bubbles containing in the water when the water is used to clean the fruits and vegetables, and effective cleaning of the fruits and the vegetables can be realized.

### (a) TECHNICAL FIELD OF THE INVENTION

The present invention generally relates to a fruit and vegetable cleaning device, and more particularly to a cleaning device that is effective in removing residuals of pesticides from fruits and vegetables.

### (b) DESCRIPTION OF THE PRIOR ART

Pesticides are commonly used in modern agriculture of fruits and vegetables. Farmers often spray pesticides on fruits and vegetables and an amount of the pesticides is left on the fruits and vegetables to protect the fruits and vegetables against insects. After harvested, the fruits and vegetables will be cleaned with a cleaning device to remove the residuals of pesticides, and then fresh-keeping processing may be carried out on the harvested fruits and vegetables. After such processing, the fruits and vegetables are shipped to markets for sale.

The fruits and vegetables, after being purchased by a consumer, is often subjected to further cleaning before being cooked and/or eaten. Such cleaning is often done with water rinsing by positioning the fruits and vegetables in the water flow from a tap. It is quite common that even the fruits and vegetables are cleaned so many times, there is still some residual of the pesticides on the surface of the fruit or vegetable. Consumers are exposed to the risk of being chronically intoxicated by the residuals of pesticides. The health of the consumer is thus damaged.

In view of such a problem, the present invention aims to provide a fruit and vegetable cleaning device that is effective in completely cleaning fruits and vegetables and reducing the residuals of pesticides.

### SUMMARY OF THE INVENTION

A technical solution of the present invention comprises is to provide a fruit and vegetable cleaning device, which comprises a base, a pump, and a pressure vessel. The pump is mounted on the base and comprises a water feeding pipe connecting a water inlet port and the pressure vessel. The pressure vessel comprises a water discharge port and an electromagnetic valve. The electromagnetic valve comprises air inlet and discharge pipes. The pump supplies water to the pressure vessel to allow air to mix with the water inside the pressure vessel, making the water full of tiny air bubbles, whereby residual pesticides remaining on fruits and vegetables may attach to the tiny air bubbles containing in the water and effective cleaning of the fruits and the vegetables can be realized.

Another technical solution of the present invention is to provide a fruit and vegetable cleaning device, which comprises a base, a pump, and a pressure vessel. The pump is mounted on the base and comprises a water feeding pipe connecting a water inlet port and the pressure vessel. The pressure vessel comprises a water discharge port and an electromagnetic valve. The electromagnetic valve comprises air inlet and discharge pipes. The pump supplies water to the pressure vessel to allow air to mix with the water inside the pressure vessel, making the water full of tiny air bubbles. The pressure vessel comprises a pressure detector, whereby when the pressure detector detects an excessive pressure inside the pressure vessel, the electromagnetic valve is actuated to release excessive air through the air discharge pipe to the surrounding so as to maintain pressure balance inside the pressure vessel.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a fruit and vegetable cleaning device according to the present invention.

FIG. 2 is a front elevational view showing the fruit and vegetable cleaning device according to the present invention.

FIG. 3 is a front elevational view showing movement of air flow and water flow in the fruit and vegetable cleaning device according to the present invention.

FIG. 4 is a side elevational view showing the fruit and vegetable cleaning device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

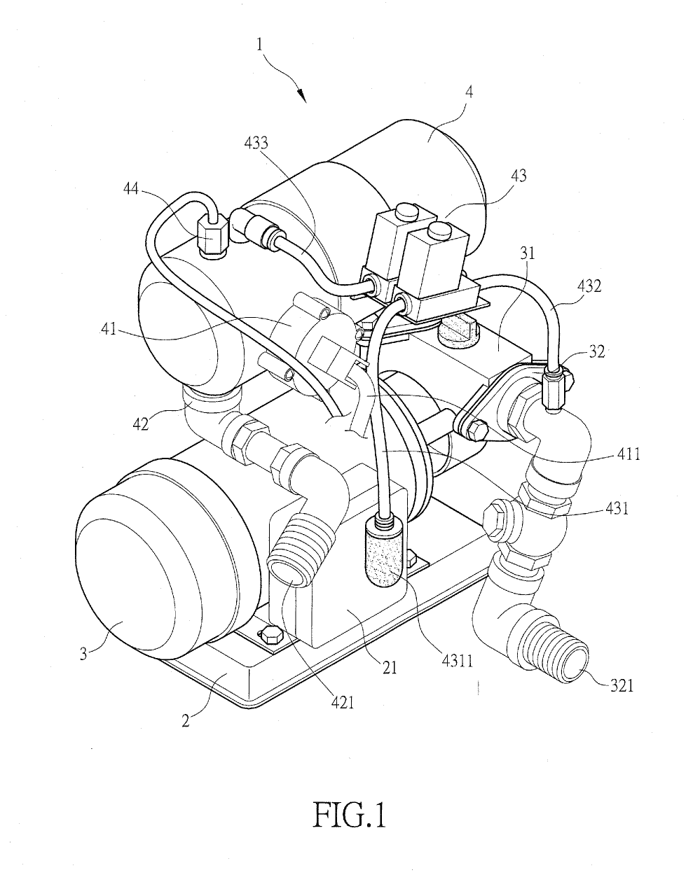

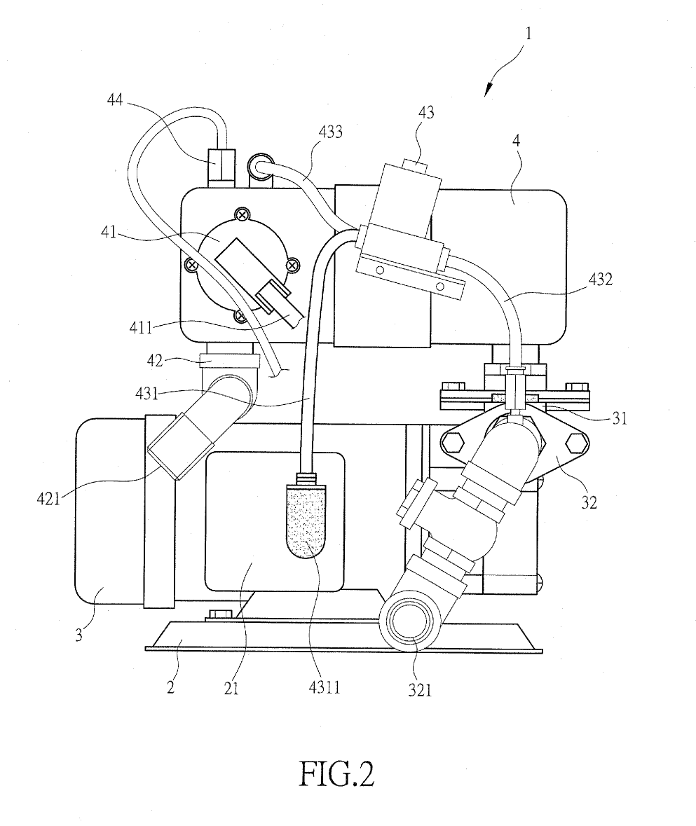

Referring to FIGS. 1 and 2, the present invention provides a fruit and vegetable cleaning device 1, which comprises a base 2, a pump 3, and a pressure vessel 4.

The base 2 functions to receive the pump 3 mounted thereon. The base 2 is also provided with a wiring case 21.

The pump 3 comprises a water feeding pipe 31 connecting a water inlet port 32 and the pressure vessel 4. The water inlet port 32 is connected to a water inlet pipe 321, which is selectively connected to for example a kitchen water tap.

The pressure vessel 4 comprises a low pressure valve 41, a water discharge port 42, an electromagnetic valve 43, and a pressure detector 44. The low pressure valve 41 is arranged on a side of the pressure vessel 4 and comprises a power supply cable 411 connected to the wiring case 21. The low pressure valve 41 is operable to reduce the internal pressure of the pressure vessel 4 to induce a negative pressure inside the pressure vessel 4. The water discharge port 42 is formed on a front end of the pressure vessel 4. A water discharge pipe 421 extends from the water discharge port 42. The electromagnetic valve 43 comprises an air supply pipe 431, an air inlet pipe 432, and an air discharge pipe 433. The air supply pipe 431 comprises a filter 4311, which filters off dusts and debris from the surrounding air. The air inlet pipe 432 is arranged at an opposite end of the air supply pipe 431 and is connected to an upstream end of the water inlet port 32. Further, the air discharge pipe 433 is arranged between the electromagnetic valve 43 and the pressure vessel 4. The pressure detector 44 is mounted on the pressure vessel 4 to detect air pressure inside the pressure detector 44 for actuating the electromagnetic valve 43 to timely relieve pressure.

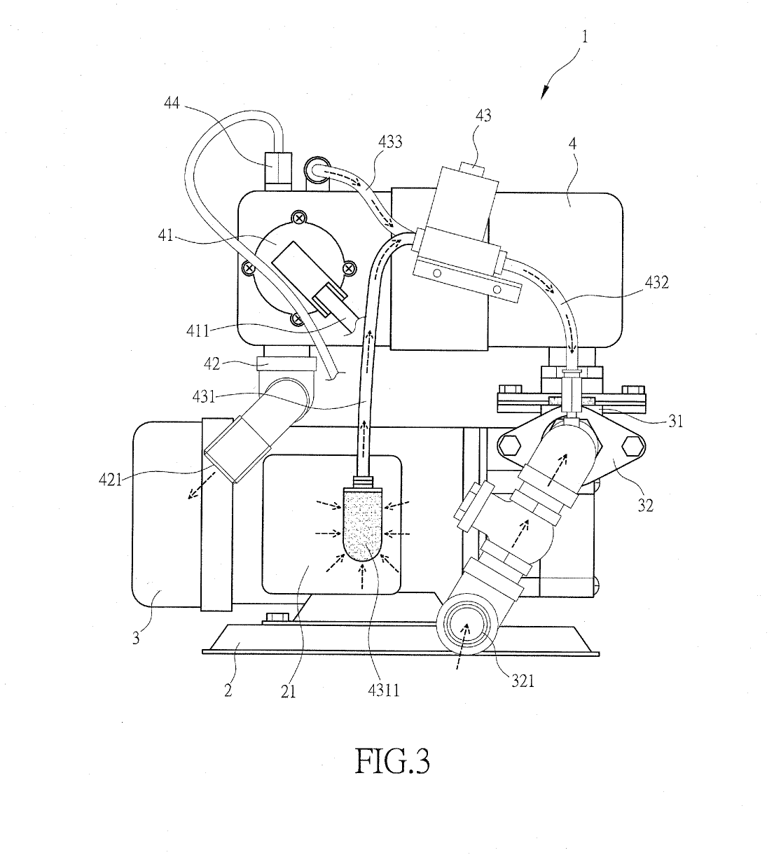

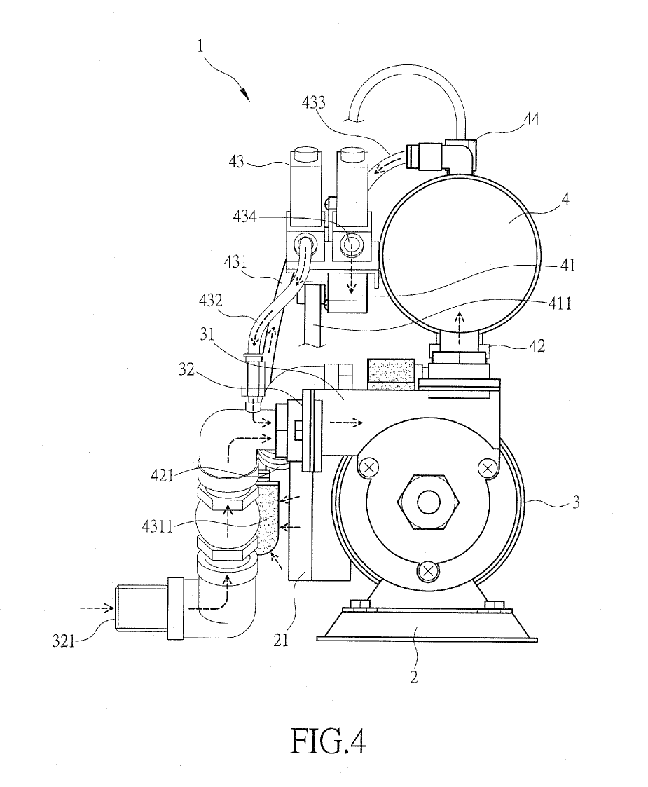

To practice the present invention, as shown in FIGS. 3 and 4, the water inlet pipe 321 is connected to a kitchen water tap. When the water tap is opened, power supply is actuated to drive the pump 3 to pump water to the water inlet port 32. Meanwhile, the air supply pipe 431 of the electromagnetic valve 43 draws the surrounding air through the filter 4311 to the air inlet pipe 432, whereby the air and the water are mixed in the pressure vessel 4, generating tiny air bubbles mixed in the water contained in the pressure vessel 4 thereby increasing the amount of oxygen dissolved in the water. The water that contains the tiny air bubbles is allowed to flow out of the water discharge pipe 421 and can be used to clean fruits and vegetables. Since the pressure vessel 4 functions to increase the water flow speed and allows the tiny air bubbles to entrain the water flow to reach the surface of fruits or vegetables, where the air bubbles causes an effect of oscillation similar to ultrasonic vibration that helps throughout cleaning and removing residuals of pesticides from the fruits or vegetables.

Further, when the pressure detector 44 detects an excessive high pressure inside the pressure vessel 4, an air discharge hole 434 of the electromagnetic valve 43 is immediately opened, whereby excessive air can be discharged to the surrounding through the air discharge pipe 433 and the air discharge hole 434 in order to maintain pressure balance inside the pressure vessel 4.

The present invention offers the following efficacies. With the arrangement that the pump 3 comprises a water feeding pipe 31 connecting the water inlet port 32 and the pressure vessel 4, a pressure vessel 4 comprises a water discharge port 42 and an electromagnetic valve 43, the electromagnetic valve 43 comprises air inlet and discharge pipes 432, 433, the pump 3 supplies water into the pressure vessel 4 to allow air to mix with the water inside the pressure vessel 4 and make the water full of tiny air bubbles, whereby residual pesticides remaining on fruits and vegetables can attach to the tiny air bubble contained in the water and effective cleaning of the fruits and vegetables can be realizes. Further, the pressure vessel 4 is provided with a pressure detector 44, whereby when the pressure detector 44 detects an excessive pressure inside the pressure vessel 4, the electromagnetic valve 43 is actuated to release excessive air through the air discharge pipe 433 to the surrounding in order to maintain pressures balance inside the pressure vessel 4.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fruit and vegetable cleaning device, comprising:
a base, on which a pump is mounted, the base comprising a wiring case mounted thereto;
a pump, which is mounted on the base and comprises a water feeding pipe connecting a water inlet port and a pressure vessel; and
a pressure vessel, which comprises a water discharge port and an electromagnetic valve, the electromagnetic valve comprising air inlet and discharge pipes and an air supply pipe, and
characterized in that the pump supplies water to the pressure vessel and the air supply pipe supplies air, whereby air and water are mixed in the pressure vessel so as to provide a water flow containing tiny air bubbles.

2. The fruit and vegetable cleaning device according to claim 1, wherein the pressure vessel comprises a low pressure valve.

3. The fruit and vegetable cleaning device according to claim 1, wherein the air supply pipe comprises a filter.

4. The fruit and vegetable cleaning device according to claim 1, wherein the air inlet pipe is connected to an upstream side of the water inlet port.

5. The fruit and vegetable cleaning device according to claim 1, wherein the pressure vessel comprises a pressure detector.
